(19) United States
(12) Patent Application Publication
(10) Pub. No.: US 2026/0265567 A1
(43) Pub. Date: Sep. 10, 2026

(54) Antimicrobial-Coated Water Faucet with Dual-Layer Elastomeric Structure

(71) Applicant: Tambi Adnan Yamek, Silicone Oasis (AE)

(72) Inventor: Tambi Adnan Yamek, Silicone Oasis (AE)

(21) Appl. No.: 19/037,220

(22) Filed: Jan. 26, 2025

(51) Int. Cl. C09D 121/00; C09D 1/00; E03B 1/04

(52) U.S. Cl. CPC C09D 121/00; C09D 1/00; E03B 1/04

(57) ABSTRACT

This invention introduces an antimicrobial-coated water faucet for bathroom and kitchen use, constructed from ABS plastic and featuring a dual-layer elastomeric coating. The coating comprises a primer layer for adhesion and a top elastomeric layer infused with antimicrobial agents, such as silver ions or titanium dioxide. The top layer provides enhanced hygiene, resistance to hard water scaling, and durability against household cleaning agents. The coating is engineered for uniform application, long-term wear resistance, and compatibility with environmentally friendly production methods. The faucet's innovative design optimizes functionality and safety, offering an advanced solution for residential plumbing fixtures.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates to plumbing fixtures, specifically water faucets for bathrooms and kitchens. It focuses on faucets made from Acrylonitrile Butadiene Styrene (ABS) plastic, featuring an advanced elastomeric coating. The coating is infused with antimicrobial agents, such as silver ions or titanium dioxide, to ensure enhanced hygiene. Additionally, it offers resistance to hard water scaling, compatibility with household cleaning agents, and long-term durability. The invention also introduces a dual-layer structure for the coating, with a primer layer for adhesion and a functional elastomeric top layer, which may utilize rubber or silicone.

### Description of the Related Art

Water faucets are an essential part of both bathrooms and kitchens, serving as daily-use fixtures in households, commercial spaces, and public areas. With advancements in technology, there has been a growing emphasis on improving the functionality, durability, and hygiene of these everyday devices. The integration of innovative materials and coatings into faucet designs is redefining the user experience while addressing key challenges such as durability and maintenance.

The importance of water faucets extends beyond convenience, as they directly impact hygiene, water conservation, and maintenance costs. Faucets with enhanced features, such as antimicrobial properties and durability, help prevent the growth of harmful microbes and reduce the buildup of hard water scaling. These advancements are crucial, especially in high-traffic areas where sanitation is paramount. Moreover, as consumer preferences shift toward sustainable and low-maintenance products, materials like ABS plastic and functional coatings provide a cost-effective and environmentally friendly solution.

According to market research, the global faucet market is projected to reach USD 50 billion by 2030, driven by rising urbanization and consumer demand for high-performance, hygienic, and aesthetically pleasing fixtures. Studies indicate that traditional faucets are prone to microbial contamination, contributing to 30-40% of infections in public restrooms. Antimicrobial coatings, such as those infused with silver ions or titanium dioxide, have been proven to reduce microbial activity by over 99%, offering a significant improvement in sanitation. Additionally, durable materials like ABS plastic have been shown to extend the lifespan of faucets by 25-30% compared to conventional metals under similar conditions.

Leading faucet manufacturers have embraced antimicrobial and water-saving technologies to meet the demands of modern consumers. Brands like Kohler and Moen have introduced faucets with built-in touchless sensors to minimize contact and reduce contamination risks. Others have developed coatings resistant to fingerprints, stains, and hard water scaling, ensuring a polished appearance over time. However, despite these innovations, few products combine antimicrobial functionality, durability, and affordability into a single design, leaving a gap in the market for more holistic solutions.

While existing faucet designs have made significant strides in functionality, several shortcomings persist. Users frequently report issues with microbial contamination, especially in shared or public spaces. Many faucets are prone to scaling and discoloration from hard water, requiring frequent cleaning and maintenance. Furthermore, household cleaning agents can degrade the finish of traditional faucets, leading to a shorter lifespan and a loss of aesthetic appeal. High-end solutions with advanced features often come with steep price tags, making them inaccessible to budget-conscious consumers.

The proposed innovative water faucet, crafted from ABS plastic and coated with a durable elastomeric layer infused with antimicrobial agents such as silver ions or titanium dioxide, addresses these pressing concerns. This dual-layer design includes a primer layer for strong adhesion and a top elastomeric coating, which enhances functionality and durability. The faucet is designed to be resistant to hard water scaling, scratches, and the wear-and-tear caused by household cleaning agents, ensuring a longer lifespan and minimal maintenance. By incorporating antimicrobial properties, the faucet promotes a hygienic environment, making it particularly beneficial for kitchens, bathrooms, and public spaces.

This invention bridges the gap in the market by combining affordability, advanced hygiene, and long-lasting performance. While many high-end faucets offer antimicrobial coatings or durability, few products integrate these features into a cost-effective and environmentally friendly package. Our ABS plastic-based faucet not only provides a lightweight and budget-friendly solution but also caters to modern consumer demands for low-maintenance and hygienic fixtures. By leveraging cutting-edge materials and design, this faucet offers a superior alternative to traditional metal designs, meeting the needs of both residential and commercial users.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims and abstract as a whole.

The present invention seeks to improve prior techniques and provide an advanced design and promotes enhanced hygiene through the use of antimicrobial agents, reducing the growth of harmful bacteria and germs by over 99%.

The invention also aims to resist hard water scaling, ensuring a cleaner and more polished appearance with minimal maintenance.

A further objective of the present invention is to offer durability against common household cleaning agents, preventing surface degradation and extending the product's lifespan.

It is also an object of the invention is to deliver a cost-effective alternative to traditional metal faucets by using lightweight, affordable ABS plastic without compromising quality.

It is further the objective of the invention to incorporate a dual-layer design for enhanced adhesion and functionality, ensuring superior performance and reliability over time.

It is also the objective of the invention to provide a lightweight and user-friendly product, simplifying installation and reducing handling difficulties.

The objective of the invention is to minimize environmental impact by utilizing ABS plastic, which is recyclable and less resource-intensive than metal counterparts.

It is also the objective of the invention to ensure compatibility with modern interior aesthetics, offering a sleek and versatile design suitable for kitchens, bathrooms, and commercial spaces.

It is further the objective of the invention to reduce maintenance costs by offering a faucet that resists scaling, scratching, and discoloration even in high-usage environments.

The invention aims to cater to a wider consumer base by delivering a premium-quality faucet at an affordable price, making advanced hygiene and durability features accessible to all.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As per its preferred embodiments, the present invention introduces a water faucet specifically designed for bathrooms and kitchens, utilizing ABS (Acrylonitrile Butadiene Styrene) plastic as the primary material. ABS plastic was selected for its lightweight nature, durability, and versatility, allowing the faucet to maintain its structural integrity under regular use while being cost-effective to produce. Its smooth surface and ease of molding make it an ideal substrate for advanced coating applications, ensuring that the final product is both functional and aesthetically appealing. The faucet design prioritizes user safety, hygiene, and convenience, catering to the needs of modern households and commercial settings.

As per its further embodiments, the core of the invention is a dual-layer elastomeric coating that provides both protective and functional benefits. The first layer, or primer layer, is applied directly to the ABS substrate. This layer forms a robust bond with the plastic, creating a base for the top elastomeric layer to adhere to. Without the primer, elastomeric coatings are prone to peeling or delamination, especially in high-moisture environments like kitchens and bathrooms. By forming a chemical or mechanical bond with the ABS plastic, the primer layer ensures the long-term durability of the overall coating system, even under frequent exposure to water and cleaning agents.

As per its further embodiments, the top layer of the coating is the functional elastomeric layer, which is infused with antimicrobial agents such as silver ions or titanium dioxide. These agents have been scientifically proven to inhibit the growth of bacteria and fungi, thereby maintaining a hygienic faucet surface. The antimicrobial agents are embedded uniformly within the elastomeric matrix, ensuring consistent performance across the entire surface. This layer is also designed to be hydrophobic, preventing water and contaminants from adhering to the faucet. This property not only enhances hygiene but also simplifies cleaning by reducing the buildup of dirt, grime, and hard water stains.

As per its further embodiments, the critical feature of the elastomeric layer is its resistance to hard water scaling. Hard water deposits, which are common in many households, can degrade the functionality and appearance of traditional faucets. The elastomeric layer in this invention incorporates hydrophobic additives that repel water, minimizing the accumulation of mineral deposits. This makes the faucet highly suitable for areas with mineral-rich water supplies, as it significantly reduces maintenance requirements. Users benefit from a faucet that retains its pristine appearance and functionality over extended periods of use.

As per its further embodiments, the durability is another essential aspect of the elastomeric layer. The coating is engineered to withstand the effects of household cleaning agents, including abrasive chemicals and detergents, without losing its antimicrobial properties or structural integrity. The material options for the elastomeric layer, such as silicone or rubber, are chosen for their flexibility and resilience. Silicone, in particular, offers superior resistance to temperature fluctuations, making it an ideal choice for faucets exposed to hot and cold water alternately. Rubber, on the other hand, provides enhanced impact resistance and elasticity. Both options ensure that the faucet remains reliable and visually appealing over time.

As per its further embodiments, the faucet's design plays a significant role in ensuring the effectiveness of the coating. The ABS body is molded with smooth, rounded surfaces, which allow the elastomeric coating to be applied uniformly. This eliminates weak points where the coating might wear off or delaminate. Additionally, the absence of sharp edges and intricate crevices minimizes areas where dirt and scaling could accumulate. This thoughtful design approach not only enhances the faucet's overall hygiene but also contributes to its long-lasting performance and ease of maintenance.

As per its further embodiments, the invention also prioritizes environmental sustainability. The ABS plastic used in the faucet is lightweight, reducing material usage and transportation costs. The antimicrobial agents in the elastomeric layer are carefully selected to be safe for residential use and environmentally friendly. Furthermore, the manufacturing process can be automated, ensuring consistency in coating application while minimizing waste. This eco-conscious approach makes the faucet a sustainable choice for consumers seeking a balance between hygiene, durability, and environmental responsibility.

As per its further embodiments, the antimicrobial-coated ABS faucet represents a significant advancement in residential plumbing fixtures. Its dual-layer elastomeric coating provides enhanced hygiene, durability, and resistance to hard water scaling, while its user-friendly design ensures ease of cleaning and maintenance. By integrating advanced materials and sustainable manufacturing practices, the invention offers a reliable, long-lasting, and aesthetically pleasing solution for bathrooms and kitchens.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A water faucet made from ABS plastic, comprising a dual-layer elastomeric coating that includes:
A primer layer bonded to the ABS plastic to enhance adhesion; and
A top elastomeric layer infused with antimicrobial agents, wherein the top elastomeric layer provides antimicrobial activity, resistance to hard water scaling, and durability against cleaning agents.
As per claim 1, the primer layer is designed to form a chemical bond with the ABS plastic surface, ensuring long-term durability of the top elastomeric layer.
As per claim 1, the top elastomeric layer comprises either silicone or rubber to provide flexibility and resilience against wear and tear.
As per claim 1, the coating's resistance to hard water scaling is achieved through hydrophobic additives in the elastomeric layer.
As per claim 1, the elastomeric layer retains its structural integrity and antimicrobial properties after exposure to common household cleaning agents. As per claim 1, the elastomeric layer's antimicrobial agents are silver ions, uniformly distributed to ensure consistent antibacterial performance.
As per claim 1, the dual-layer coating prevents delamination or peeling during extended use.
As per claim 1, the elastomeric layer is formulated to provide scratch resistance during routine handling.

2. The faucet wherein the top elastomeric layer is infused with antimicrobial agents that inhibit bacterial and fungal growth on the surface of the faucet.
As per claim 2, the antimicrobial agents are selected from silver ions or titanium dioxide, designed to provide long-lasting antimicrobial activity.
As per claim 2, the antimicrobial agents remain effective over prolonged use, maintaining hygienic conditions.
As per claim 2, the antimicrobial coating prevents biofilm formation on the faucet's surface, enhancing overall cleanliness.
As per claim 2, the coating is tested and certified to meet non-toxicity standards for residential and commercial use.
As per claim 2, the antimicrobial efficacy of the coating persists after multiple cleaning cycles with harsh chemicals.
As per claim 2, the antimicrobial layer is environmentally friendly and free of hazardous substances.
As per claim 2, the elastomeric coating layer provides an aesthetically smooth and uniform finish.

3. The faucet wherein the ABS plastic construction is designed for optimized durability and ease of coating application.
As per claim 3, the ABS plastic body is molded to provide smooth and even surfaces that enhance adhesion of the elastomeric coating.
As per claim 3, the faucet design incorporates rounded edges to minimize coating irregularities and weak points.
As per claim 3, the silicone-based elastomeric layer is formulated to resist temperature variations and maintain flexibility.
As per claim 3, the materials used in the faucet's construction are selected to support environmentally friendly manufacturing processes.
As per claim 3, the faucet design ensures consistent water flow while reducing noise during operation.
As per claim 3, the coating process is compatible with automated manufacturing for large-scale production.
